(19) United States
(12) Patent Application Publication
(10) Pub. No.: US 2013/0191172 A1
(43) Pub. Date: Jul. 25, 2013

(54) TICKET TRANSFER

(71) Applicants: Mark Tacchi, San Francisco, CA (US); Marco Matarazzi, Gualdo Tadino (IT); Andrea Sprega, Gualdo Tadino (IT); Tim Gerk, San Francisco, CA (US)

(72) Inventors: Mark Tacchi, San Francisco, CA (US); Marco Matarazzi, Gualdo Tadino (IT); Andrea Sprega, Gualdo Tadino (IT); Tim Gerk, San Francisco, CA (US)

(21) Appl. No.: 13/738,354

(22) Filed: Jan. 10, 2013

Related U.S. Application Data
(60) Provisional application No. 61/589,858, filed on Jan. 23, 2012.

(51) Int. Cl. G06Q 10/02

(52) U.S. Cl. CPC G06Q 10/02
USPC 705/5

(57) ABSTRACT

A system and method transfers a ticket from one party to another through a ticketing application in a computing device. A purchased ticket may be electronically received by the user and saved to a database accessible by the computing device. The ticket may be assigned a unique fingerprint to prevent fraudulent activity. The ticketing application receives a selection of one or more tickets to be transferred to another party. A transfer recipient (having access to the ticketing application) is identified. In one embodiment, a user may request a payment amount from the transfer recipient for the transferred ticket. Once a user has identified a transfer recipient and payment amount (if applicable), the user may then confirm and/or authorize the transfer.

### RELATED APPLICATIONS

The present application claims priority to U.S. Provisional Application Ser. No. 61/589,858, filed Jan. 23, 2012, the disclosure of which is incorporated by reference.

### BACKGROUND

1. Field of the Invention

The present invention generally concerns event ticket purchasing and processing. More particularly, the present invention relates to transferring a purchased ticket from one user to another.

2. Description of the Related Art

Traditionally, a paper ticket is issued and sold for each available seat at a live event or performance such as a concert, movie, ballet, or sporting event. A party wishing to attend the event is usually tasked with finding an available ticket, purchasing the ticket, receiving the purchased ticket (i.e., via e-mail, mail, or will call), and presenting the ticket to gain entry into the event.

A problem may arise when a party wants to purchase multiple tickets for a group of attendees or when the attendee holds an issued ticket to an event but can no longer attend. When an attendee has purchased multiple tickets for a group of attendees, for example, the attendee is faced with the hassle of physically distributing the tickets to the attendees and, if applicable, collecting payment from each attendee for the same, both of which may involve a considerable amount of time, travel, and logistical planning. A similar situation occurs when the attendee can no longer attend the event. To prevent the ticket from going unused, the attendee has to find a way to issue the purchased ticket to another person who is available to attend the event and collect payment for the same.

There is a need for an improved system and method for transferring a purchased event ticket from one party to another.

### SUMMARY OF THE CLAIMED INVENTION

A method transfers an electronically-stored ticket from one party to another through a ticketing application in a computing device, such as a mobile phone. A purchased ticket may be electronically received by the user and saved to a database accessible by the computing device. The ticket may be assigned a unique fingerprint to prevent fraudulent activity, such as more than one party attempting to use the same ticket for the same event. The ticketing application receives a selection of one or more tickets to be transferred to another party. A user then identifies a transfer recipient, who also has access to the ticketing application via a computing device, such as a mobile phone. Once a user has identified a transfer recipient, the user may then confirm the transfer of the electronic ticket to the transfer recipient.

A system facilitates the transfer of an electronically-stored ticket from one party to another transfer using a server, including memory, at least one processor, and instructions, and computing devices, connected over a network. The server generates a graphical interface, on which the user can receive the electronic ticket, which is assigned a unique fingerprint to prevent fraudulent activity. The user then identifies a transfer recipient. Once a user has identified a transfer recipient, the user may then confirm the transfer of the electronic ticket.

### BRIEF DESCRIPTION OF THE FIGURES

FIG. 1 illustrates a method for ticket transfer.

FIG. 2A illustrates an exemplary graphical interface for loading one or more received ticket a ticketing application.

FIG. 2B illustrates an exemplary graphical interface for viewing order details about a ticket that has been loaded into the ticketing application and for initiating a ticket transfer.

FIG. 2C illustrates an exemplary graphical interface for selecting the specific ticket(s) to transfer.

FIG. 2D illustrates an exemplary graphical interface for identifying a transfer recipient, requesting payment for the ticket transfer, and authorizing the ticket transfer.

FIG. 2E illustrates an exemplary graphical interface for receiving a notification of an incoming ticket transfer.

FIG. 2F illustrates an exemplary graphical interface for viewing details of an incoming ticket transfer and accepting or refusing the incoming ticket transfer.

FIG. 2G illustrates an exemplary graphical interface for confirming an acceptance or refusal of the ticket transfer.

FIG. 2H illustrates an exemplary graphical interface for viewing pending incoming ticket transfers, outgoing transfers, and past ticket transfers.

FIG. 3 illustrates a computing system that may be used to implement the method of FIG. 1.

### DETAILED DESCRIPTION

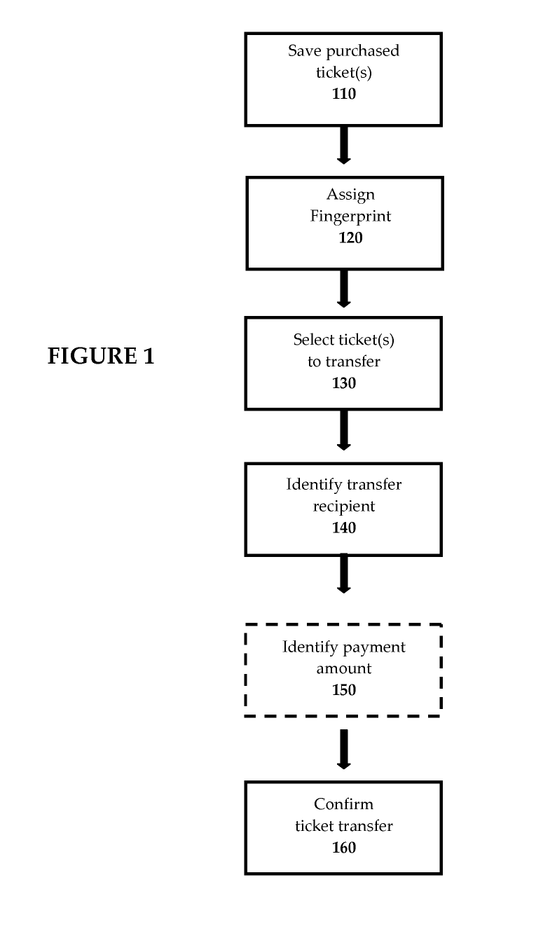

Embodiments of the present invention provide a system and method for transferring a ticket from one party to another. FIG. 1 illustrates a method for ticket transfer. The steps identified in FIG. 1 (and the order thereof) are exemplary and may include various alternatives, equivalents, or derivations thereof including but not limited to the order of execution of the same. The steps of the method of FIG. 1 (and its various alternatives) may be embodied in hardware or software including a non-transitory computer-readable storage medium (e.g., an optical disc or memory card) having instructions executable by a processor of a computing device.

A ticketing application may be implemented by one or more processors that execute instructions stored in memory mediums. The executed code may result in the processor(s) generating one or more graphical interfaces.

Referring now to FIG. 1, a user may launch or activate the method by opening or activating an application (e.g., a ticketing application) in a computing device, such as a mobile device, at step 100.

One or more tickets to an event may be electronically purchased by a user associated with a computing device. The purchased tickets may be digital, e-tickets, or print-at-home tickets (e.g., PDF, HTML, etc.). The tickets may be purchased by the user from any available seller, re-seller, vendor or other source. The event may be any private or public prerecorded, repeat, or live event or performance known in the art such as a concert, sporting event, show, movie, or musical recital. A purchased ticket may be electronically received by the user from the ticket seller or source and saved to a database accessible by the computing device at step 110. In another embodiment, a ticket may be received from another user of a ticketing application who has purchased the ticket.

Once loaded into the application, the purchased and/or received tickets may be assigned a unique fingerprint at step 120. The fingerprint may be used to prevent fraudulent activity associated with the ticket such as multiple uploads and ticket transfers of a single ticket to various parties. Digital watermarking, or any other method known in the art to prevent ticket duplication or tampering may be used.

At step 130, the ticketing application receives a selection of one or more tickets to be transferred to another party. Where multiple tickets are saved into a single document, the ticketing application may process the single document and separate or split the document containing multiple tickets into single tickets to allow the transfer of ticket(s) to individual parties.

At step 140, a transfer recipient (having access to the ticketing application) is identified. At optional step 150, a user may request a payment amount from the transfer recipient for the transferred ticket. At step 160, once a user has identified a transfer recipient and payment amount (if applicable), the user may then confirm and/or authorize the transfer.

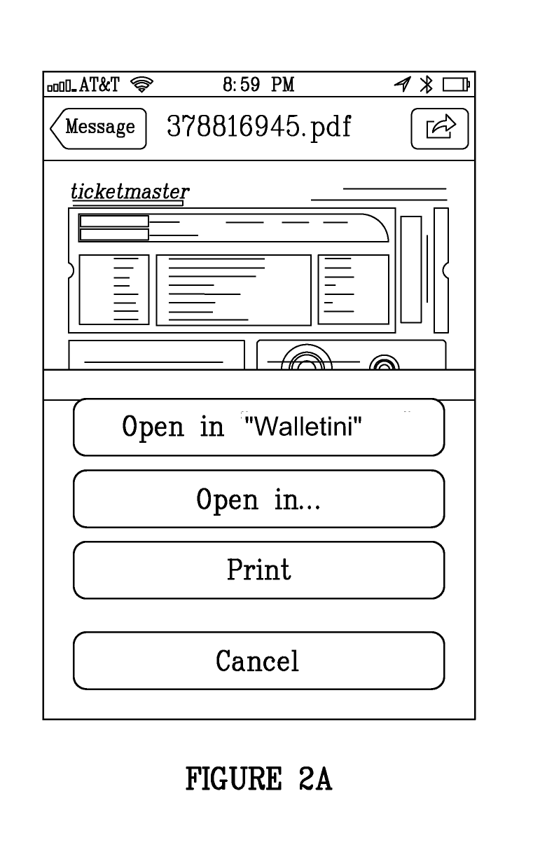

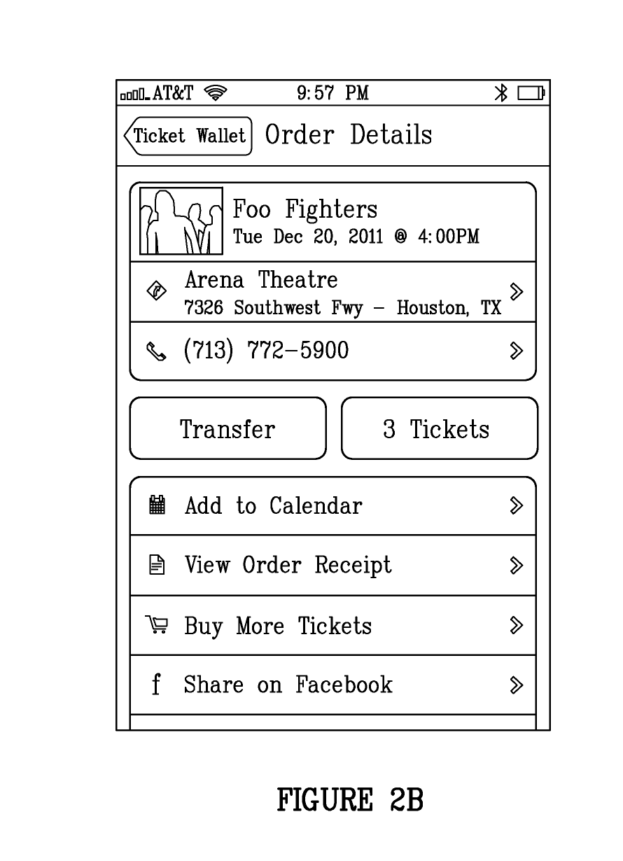

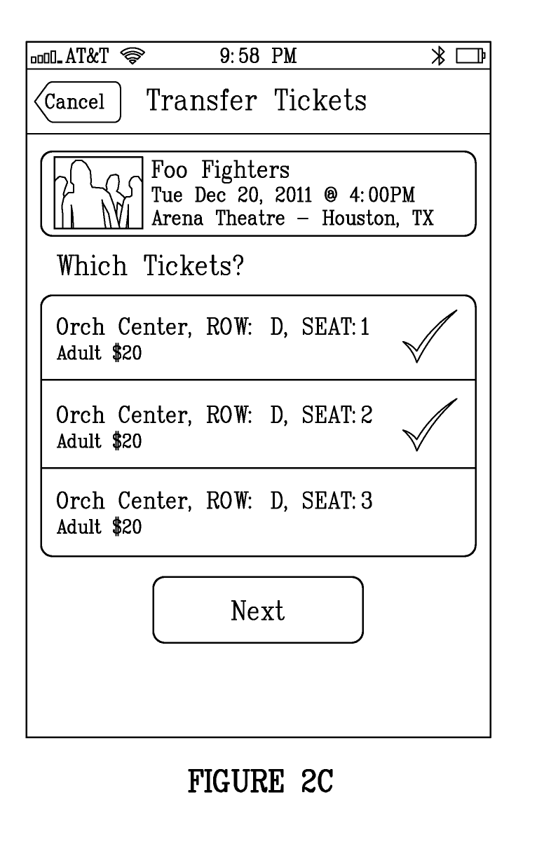

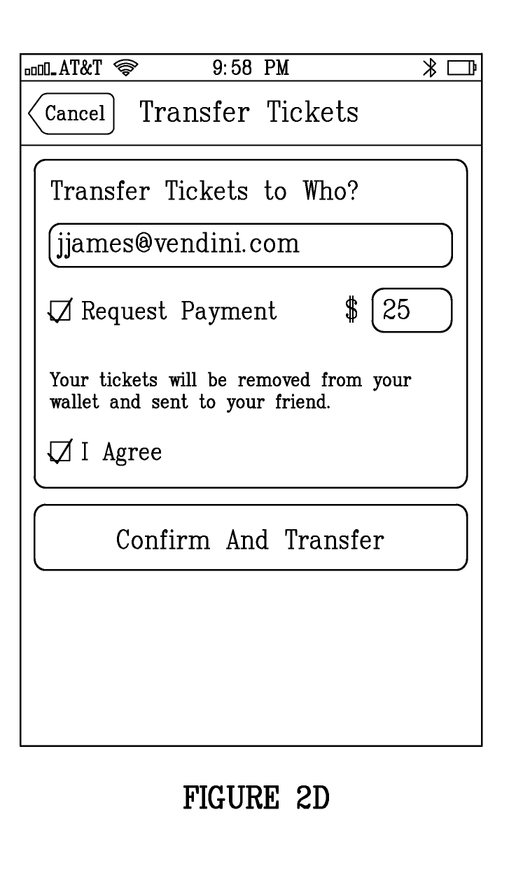

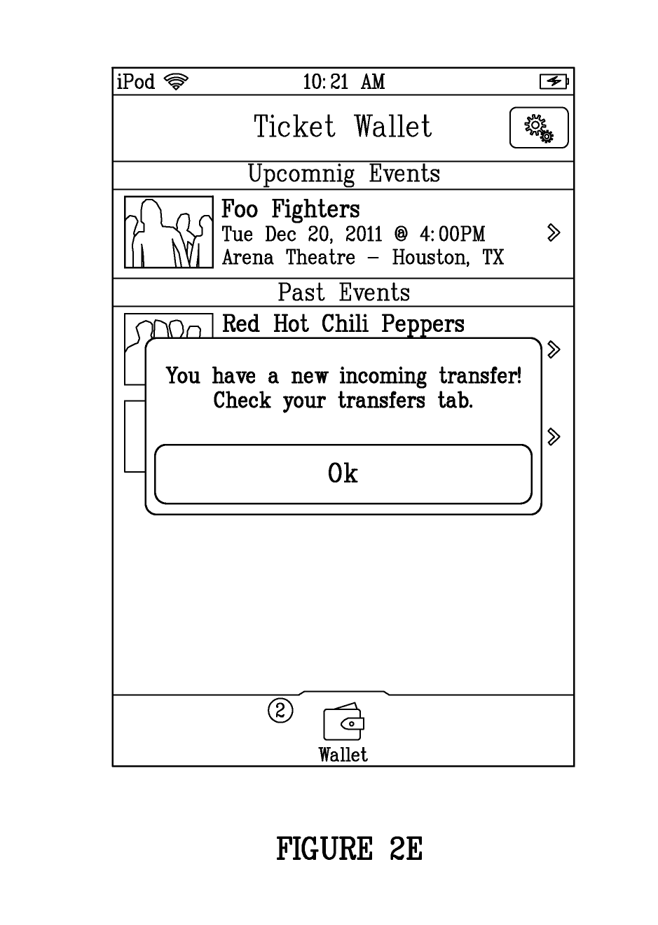

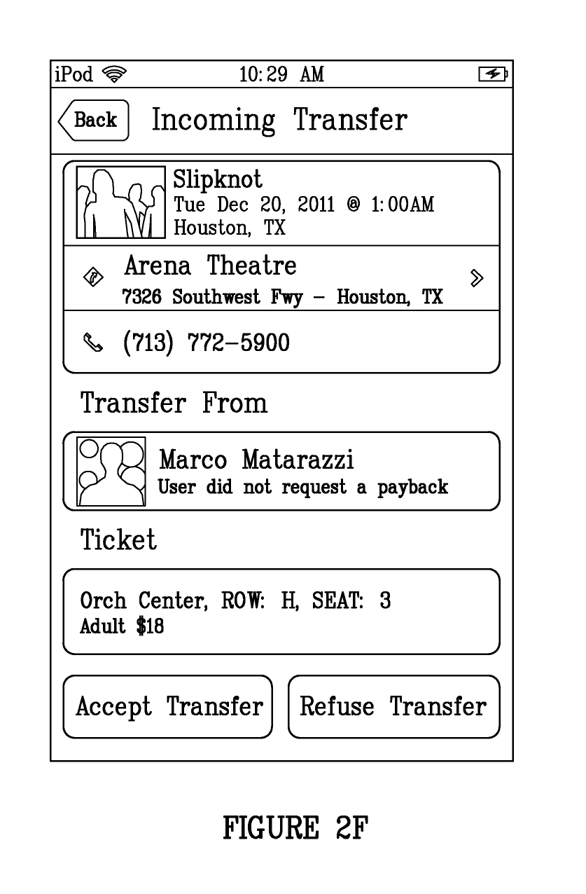

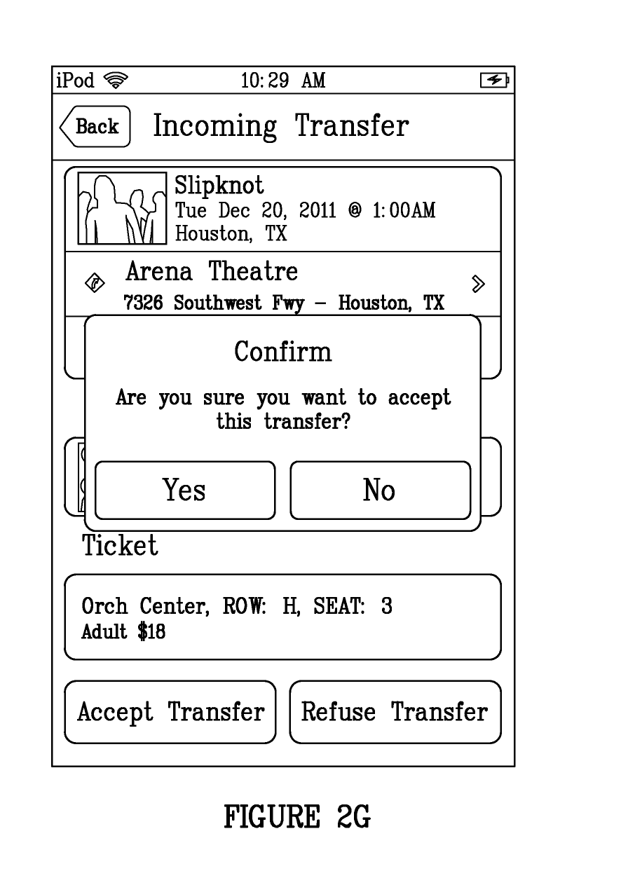

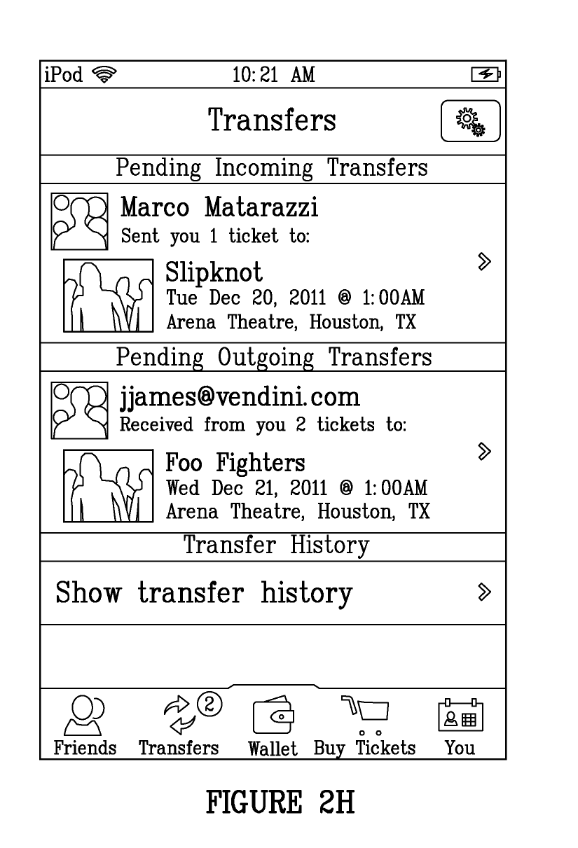

FIGS. 2A-2H illustrate exemplary interfaces for transferring a ticket from one party to another on a mobile device, where both parties have access to and accounts with the same ticketing application.

Referring now to FIG. 2A, the user may choose to load or import one or more received ticket 200 into an application for hosting electronic tickets and accessible by the computing device. The user may select an “Open” button 202 to open the ticket 200 in a ticketing application, or alternatively select an “Open in . . . ” button 204 to open the ticket 200 in a different application (not shown). The user may also select a “Print” button 206 to print the ticket 200, or a “Cancel” button 208 to cancel the importation of ticket 200.

Now referring to FIG. 2B, the user may view, on the graphical interface of the computing device, the type and number of tickets 210 that have been loaded into the application and are available for transfer. The user may also view event details 212 associated with the tickets and/or event such as the date, time, location, and contact information. The graphical interface may also present an option to the user to transfer the event to a calendar by activating the “Add to Calendar” button 214, view the receipt for the ticket purchase by selecting the “View Order Receipt” button 216, purchase more tickets for the same event by selecting the “Buy More Tickets” button 218, or share that the user is attending the event via social networks by selecting the “Share” button 220. The user may transfer tickets by selecting an event and selecting or activating the “Transfer” button 222.

Referring now to FIG. 2C, once the transfer button 222 has been activated, the user may select the specific ticket(s) to transfer by selecting individual tickets, one of which is labeled 230. Ticket(s) 230 may be individually identifiable by name, section, seat number, price, or by any other manner. After selecting ticket(s) 230, a user may select the “Next” button 232 to proceed with the transfer, or the “Cancel” button 234 to cancel the transfer.

Referring now to FIG. 2D, a user may identify the transfer recipient by name, e-mail address, username, or any other means by entering such information in transfer recipient field 240. The user may check the “Request Payment” box 242 and enter a payment amount in payment amount field 244. A payment amount may be specified by the user or chosen from pre-set amounts (not shown). The user may confirm and/or authorize the transfer by checking the “I Agree” box 246 and by activating a button such as the “Confirm And Transfer” button 248. The user may alternatively cancel the transfer by selecting the “Cancel” button 250.

Referring now to FIG. 2E, once ticket(s) 230 have been transferred, the transfer recipient identified in transfer recipient field 240 may receive a notification (e.g., e-mail message, short message service (SMS)) or an instant notification 260.

Referring now to FIG. 2F, incoming transfer details may be presented to the transfer recipient, including, for example, event details 270, such as name, date, time, and location, transferor details 272, such as name and payment amount requested, and ticket details 274. The transfer recipient may then either accept or refuse the transfer by activating an “Accept Transfer” button 276 or “Refuse Transfer” button 278. An incoming transfer may be set to expire after a predetermined time. In one embodiment, the user may set a date and/or time for the transfer recipient to accept or refuse the transfer (not shown).

Referring now to FIG. 2G, the transfer recipient may be asked to confirm an acceptance (or refusal) of the transferred ticket by selecting the “Yes” button 280 or “No” button 282 on the confirmation prompt 284. If the transfer recipient accepts the transfer, the ticket(s) are removed from the account of the user and moved to the account of the recipient. If the transfer refuses the transfer, the ticket(s) are returned to the user and the user may keep the ticket(s) or transfer the ticket(s) to a different party.

Referring now to FIG. 2H, a user of the ticketing application may view all pending incoming transfers 290 and/or outgoing transfers 292. A user may also view transfer history 294, which includes a history of all past ticket transfers.

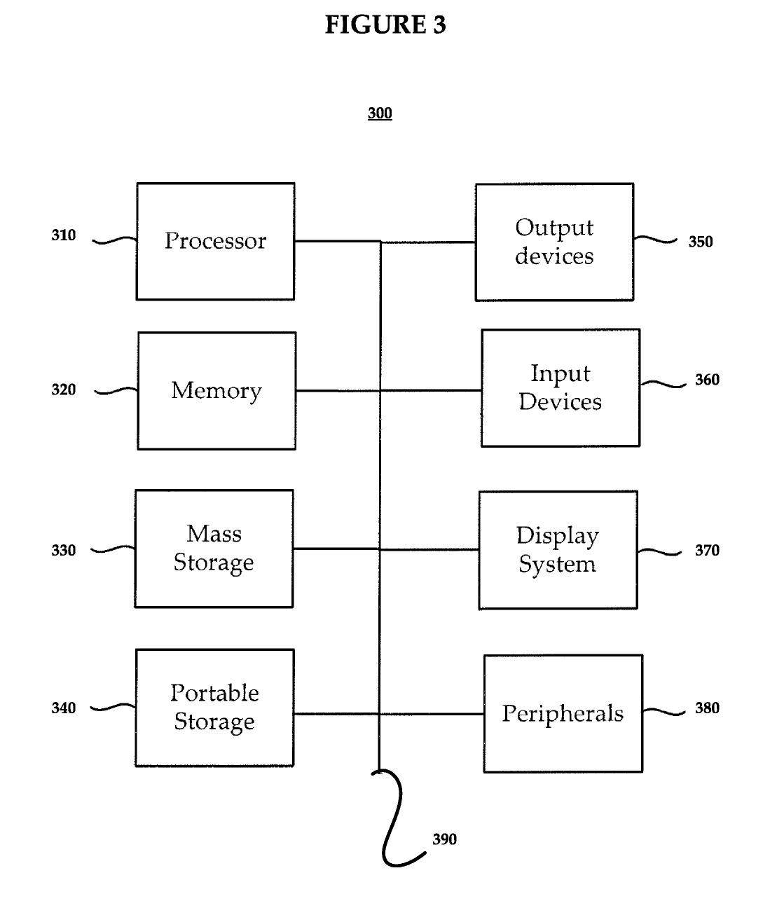

Referring now to FIG. 3, a computing system 300 is shown that may be used to implement an embodiment of the present invention. System 300 of FIG. 3 may be used to implement a computing device, network server, application server 150, and/or database operating in the context of the method of FIG. 1. The computing system 300 of FIG. 3 includes one or more processors 310 and memory 320. Main memory 320 stores, in part, instructions and data for execution by processor 310. Main memory 320 can store the executable code when in operation. The system 300 of FIG. 3 further includes a mass storage device 330, portable storage medium drive(s) 340, output devices 350, user input devices 360, a graphics display 370, and peripheral devices 380.

The components shown in FIG. 3 are depicted as being connected via a single bus 390. The components, however, may be connected through one or more data transport means. For example, processor unit 310 and main memory 320 may be connected via a local microprocessor bus, and the mass storage device 330, peripheral device(s) 380, portable storage device 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 may store the system software for implementing embodiments of the present invention for purposes of loading software into main memory 320.

Portable storage device 340 operates in conjunction with a portable nonvolatile storage medium, such as a floppy disk, compact disk or Digital video disc, to input and output data and code to and from the computer system 300 of FIG. 3. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors.

Display system 370 may include a liquid crystal display (LCD) or other suitable display device. Display system 370 may receive textual and graphical information, and process the information for output to the display device.

Peripherals 380 may include any type of computer support device to add additional functionality to the computer system. For example, peripheral device(s) 380 may include a modem or a router.

The components contained in the computing system 300 of FIG. 3 are those typically found in computer systems that may be suitable for use with embodiments of the present invention and are intended to represent a broad category of such computer components that are well known in the art. Thus, the computing system 300 of FIG. 3 may be a personal computer, hand held computing device, tablet device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows Mobile, or iOS. The steps of the method of FIG. 1 (and its various alternatives) may be performed by a module or engine stored on a computer readable storage medium (e.g., optical disc, memory card, etc.) comprising instructions executable by a processor of a computing device.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claim and otherwise appreciated by one of ordinary skill in the art.

What is claimed is:

1. A method for ticket transfer, the method comprising:
open a ticketing application on the computing device,
receiving at least one ticket on a computing device;
assigning a fingerprint to the ticket;
selecting one or more tickets from a plurality of tickets stored in a database to transfer to the transfer recipient;
identifying a transfer recipient; and
confirming the transfer of the one or more ticket to the transfer recipient.

2. The method of claim 1, wherein the at least one ticket received on the computing device is purchased by the user associated with the computing device.

3. The method of claim 1, wherein the user purchases the at least one ticket received on the computing device as a digital ticket.

4. The method of claim 1, wherein the user purchases at least one ticket received on the computing device as a print-at-home ticket.

5. The method of claim 1, wherein the user purchases the at least one ticket received on the computing device from a ticket vendor.

6. The method of claim 1, wherein the user purchases the at least one ticket received on the computing device from a second user of the ticketing application.

7. The method of claim 1, wherein the user identifies the transfer recipient by name, e-mail address, or username.

8. The method of claim 1, further comprising requesting a payment amount from the transfer recipient for the ticket.

9. The method of claim 8, wherein a user specifies the payment amount.

10. The method of claim 8, wherein the user chooses the payment amount from a list of pre-set dollar amounts.

11. The method of claim 1, further comprising sending the transfer recipient identified in a notification of the transfer.

12. The method of claim 1, further comprising presenting details associated with the transfer to the transfer recipient.

13. The method of claim 12, wherein the details include event details, transferor details, and ticket details.

14. The method of claim 1, further comprising allowing the transfer recipient to accept or refuse the transfer.

15. The method of claim 14, further comprising setting a predetermined expiration time for the transfer recipient to accept or refuse the transfer.

16. The method of claim 15, wherein the user sets the expiration time.

17. The method of claim 14, wherein the recipient accepts the transfer, and further comprising:
removing the ticket from an account associated with the user; and
moving the ticket to an account associated with the transfer recipient.

18. The method of claim 14, wherein the recipient refuses the transfer, and further comprising:
returning the ticket to an account associated with the user; and
allowing the user to transfer the ticket to a different party.

19. The method of claim 1, further comprising allowing the user to view all pending incoming transfers, outgoing transfers, and a history of all prior ticket transfers.

20. A system for ticket transfer, the system comprising:
a server that generates a graphical interface, the server including:
memory; and
at least one processor; and
non-transitory instructions stored in the memory and executable by the processor to:
receive at least one ticket,
assign a fingerprint to the ticket,
select one or more tickets form a plurality of tickets stored on a database;
identify a transfer recipient, and
confirm the transfer of the one or more ticket to the transfer recipient; and
a plurality of computing devices that are communicatively coupled to the server over a communications network, the plurality of computing devices allowing for interaction with the server in real time by way of the graphical interface.
